(19) United States
(12) Patent Application Publication
(10) Pub. No.: US 2020/0409284 A1
(43) Pub. Date: Dec. 31, 2020

(54) LIQUID DEVELOPER

(71) Applicant: CANON KABUSHIKI KAISHA, Tokyo (JP)

(72) Inventors: Akifumi Matsubara, Kashiwa-shi (JP); Naohiko Tsuchida, Tokyo (JP); Kohji Takenaka, Toride-shi (JP); Tomoyo Miyakai, Tokyo (JP); Kouichirou Ochi, Chiba-shi (JP); Yuya Chimoto, Funabashi-shi (JP); Masato Nakajima, Moriya-shi (JP); Yasutaka Akashi, Yokohama-shi (JP); Takashi Hirasa, Moriya-shi (JP); Yuzo Tokunaga, Chiba-shi (JP)

(21) Appl. No.: 17/020,223

(22) Filed: Sep. 14, 2020

Related U.S. Application Data
(63) Continuation of application No. PCT/JP2019/010742, filed on Mar. 15, 2019.

(30) Foreign Application Priority Data
Mar. 16, 2018 (JP) 2018-049350

(51) Int. Cl. G03G 9/13; G03G 9/125; G03G 9/135

(52) U.S. Cl. CPC G03G 9/131; G03G 9/135; G03G 9/125

(57) ABSTRACT

A liquid developer comprising a toner particle, a carrier liquid, and a basic toner particle dispersing agent, wherein the toner particle contains a polyester resin A, and the polyester resin A contains at least one monomer unit selected from the group consisting of monomer units derived from aliphatic monocarboxylic acids having from 1 to 6 carbons and monomer units derived from aromatic monocarboxylic acids having from 7 to 12 carbons.

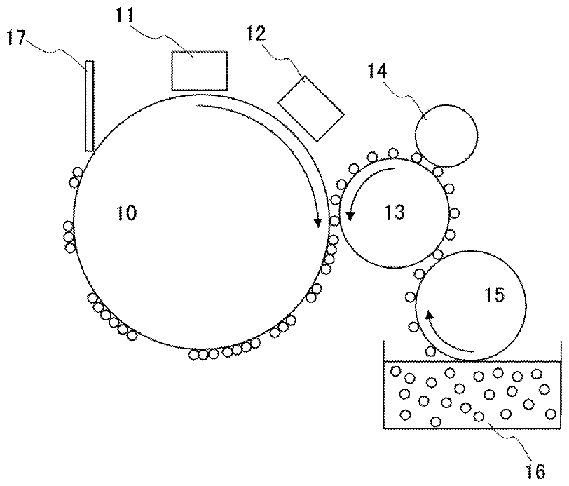

### CROSS-REFERENCE TO RELATED APPLICATIONS

This application is a Continuation of International Patent Application No. PCT/JP2019010742, filed Mar. 15, 2019, which claims the benefits of Japanese Patent Application No. 2018-049350, filed Mar. 16, 2018, both of which are hereby incorporated by reference herein in their entirety.

### BACKGROUND OF THE INVENTION

### Field of the Invention

The present invention relates to a liquid developer that is used in image-forming apparatuses that employ an electrophotographic system.

### Background Art

There has been an increase in recent years in the demands imposed by colorization on image-forming apparatuses that utilize electrophotographic systems, e.g., copiers, facsimile machines, and printers.

Within this context, there is increasing activity with regard to the development of high-image-quality, high-speed digital printers that utilize electrophotographic technology and use liquid developers, which exhibit an excellent ability to reproduce fine-line images, an excellent gradation reproducibility, an excellent color reproducibility, and an excellent capacity for high-speed image formation. In view of these circumstances, the development is required of liquid developers that have even better properties.

Liquid developers are generally provided by the dispersion of a toner particle that contains a colorant, e.g., a pigment, in an insulating liquid. As methods for producing such liquid developers, wet pulverization methods, coacervation methods, and so forth are known, but whichever method may be employed, procedure for bringing about a uniform dispersion in the insulating liquid of the toner particle, which is produced by whatever method, is crucial. When the toner particle exhibits a low dispersibility, problems may arise such as reduction in the electrophoretic behavior of the liquid developer and in its dispersion stability.

In order to solve these problems, PTL 1 proposes a method that uses an acid group-bearing high-molecular-weight compound and a basic group-bearing high-molecular-weight compound.

In this method, either one of the high-molecular-weight compounds is first adsorbed to the surface of a colorant. This colorant is then incorporated within the other one of the high-molecular-weight compounds, as a result of which a stable dispersion of the toner particle in the carrier liquid is brought about.

In addition, even a toner that exhibits a good dispersibility immediately after production may not be able to adequately maintain its storage stability for a long time. That is, a liquid developer may be stored for from several days to several months in a developer tank in an image-forming apparatus and the condition of the toner particle dispersion may change over time due to, e.g., aggregation, and as a consequence the image density, resolution, and fixing performance may decline.

PTL 2 discloses a method that improves the dispersion stability of a toner particle over time without reducing the fixing performance.

According to this method, the dispersion stability of a toner particle over time can be improved through the use of a polyester resin that has a weight-average molecular weight of at least 20,000.

### CITATION LIST

### Patent Literature

PTL 1 Japanese Patent Application Laid-open No. 2001-31900

PTL 2 Japanese Patent Application Laid-open No. 2009-251086

However, even when countermeasures such as the preceding have been implemented, for example, in a high-humidity environment, the amount of moisture in the liquid developer increases and toner particle aggregation is accelerated, and as a consequence the toner particle dispersion stability declines and the image density, resolution, and so forth are then reduced.

The present invention was pursued considering these circumstances and provides a liquid developer that maintains the dispersion stability of a toner particle in the liquid developer, even in a high-humidity environment, and that exhibits an excellent development stability over time.

### SUMMARY OF THE INVENTION

The present disclosure relates to a liquid developer comprising a toner particle, a carrier liquid, and a basic toner particle dispersing agent, wherein the toner particle contains a polyester resin A, and the polyester resin A contains at least one monomer unit selected from the group consisting of monomer units derived from aliphatic monocarboxylic acids having from 1 to 6 carbons and monomer units derived from aromatic monocarboxylic acids having from 7 to 12 carbons.

Further features of the present invention will become apparent from the following description of exemplary embodiments with reference to the attached drawings.

### BRIEF DESCRIPTION OF THE DRAWINGS

The FIGURE is a schematic diagram of an apparatus for evaluating the liquid development image quality.

### DESCRIPTION OF THE EMBODIMENTS

Unless specifically indicated otherwise, the expressions “from XX to YY” and “XX to YY” that show numerical value ranges refer in the present invention to numerical value ranges that include the lower limit and upper limit that are the end points.

In addition, monomer unit refers to the reacted form of a monomer material in the polymer or resin.

The present disclosure relates to a liquid developer comprising a toner particle, a carrier liquid, and a basic toner particle dispersing agent, wherein

the toner particle contains a polyester resin A, and

the polyester resin A contains at least one monomer unit selected from the group consisting of monomer units derived from aliphatic monocarboxylic acids having from 1 to 6 carbons and monomer units derived from aromatic monocarboxylic acids having from 7 to 12 carbons.

The present inventors hypothesize as follows with regard to the reasons that a solution to the aforementioned problem was achieved.

A basic toner particle dispersing agent generally has a basic adsorptive group and a hydrophobic dispersive group such as a hydrocarbon group. The function as a dispersing agent is exhibited through bonding by the basic adsorptive group to the acid groups possessed by the polyester resin at the toner particle surface.

However, the polyester resin also has hydroxyl groups in addition to the acid groups, and it is thought that the hydroxyl group also bonds, although weakly, with the adsorptive group in the basic toner particle dispersing agent through interactions such as hydrogen bonding.

Weak bonding, such as between this adsorptive group and the hydroxyl group in the polyester resin, is believed to have the effect immediately after liquid developer production of increasing toner particle dispersibility due to a persistence of the bonding at this point.

However, the bonding gradually collapses over time and the toner particle dispersibility declines.

Particularly in a high-humidity environment, the moisture concentration in the liquid developer is increased and this water weakens the bond between the polyester resin and toner particle dispersing agent, and the decline in the dispersibility is accelerated as a result.

When this dispersibility is reduced, for example, the 50% particle diameter on a volume basis (D50) of the toner particle is increased and the developing performance declines.

On the other hand, the polyester resin A contained by the toner particle has a monomer unit derived from a monocarboxylic acid as described above, and this serves to increase the hydrophobicity of the polyester resin A.

This increase in the hydrophobicity of polyester resin A impedes moisture access to the toner particle dispersing agent, even in a high-humidity environment, and the polyester resin-toner particle dispersing agent bonding is then not weakened and the dispersibility is maintained.

The liquid developer contains a toner particle.

This toner particle contains the polyester resin A.

This polyester resin A contains at least one monomer unit selected from the group consisting of monomer units derived from aliphatic monocarboxylic acids having from 1 to 6 carbons and monomer units derived from aromatic monocarboxylic acids having from 7 to 12 carbons.

This toner particle should contain the indicated polyester resin A, but is not otherwise particularly limited. For its resin component, this toner particle may contain an additional resin component other than polyester resin A.

The content of the polyester resin A in the resin component constituting the toner particle is preferably from 10 mass % to 95 mass % and is more preferably from 30 mass % to 85 mass %.

The polyester resin A and the additional resin component present in the toner particle are preferably both insoluble in the carrier liquid.

The metric here for insoluble in the carrier liquid is that not more than 1 mass parts of the polyester resin A and the additional resin component dissolves in 100 mass parts of the carrier liquid at a temperature of 25° C.

Specific examples of this additional resin are polyester resins other than polyester resin A, vinyl resins, polyurethane resins, epoxy resins, polyamide resins, polyimide resins, silicon resins, phenolic resins, melamine resins, urea resins, aniline resins, ionomer resins, polycarbonate resins, and so forth.

The vinyl resins can be exemplified by methacrylic resins, acrylic resins, styrene-acrylic resins, styrene-methacrylic resins, polyethylene resins, ethylene-methacrylic resins, ethylene-acrylic resins, and so forth.

A single one of these resins may be used by itself, or two or more may be used in combination.

From the standpoint of obtaining a high-definition image, the 50% particle diameter on a volume basis (D50) of the toner particle is preferably from 0.1 μm to 5.0 μm and is more preferably from 0.1 μm to 2.0 μm.

The particle size distribution of the toner particle (95% particle diameter on a volume basis (D95)/50% particle diameter on a volume basis (D50)) is preferably not more than 5, more preferably not more than 3, and still more preferably not more than 2 and particularly preferably is 1.

Having the D50 and particle size distribution be in the indicated ranges makes it possible to bring about both an excellent developing performance and a satisfactorily thin film thickness for the toner image.

The toner particle concentration in the liquid developer can be freely adjusted in accordance with the image-forming apparatus that is used, but may be approximately from 1 mass % to 70 mass %.

The polyester resin A contains at least one monomer unit selected from the group consisting of monomer units derived from aliphatic monocarboxylic acids having from 1 to 6 carbons (preferably from 1 to 3 carbons) and aromatic monocarboxylic acids having from 7 to 12 carbons (preferably from 7 to 9 carbons).

This monomer unit is preferably present in molecular chain terminal position on the polyester resin A.

These monocarboxylic acid-derived monomer units are the structures provided by removing the hydroxyl group from the carboxy group in the monocarboxylic acid.

In addition, when the polyester resin A has a branch chain, the “molecular chain terminal position” also includes the terminal position for the branch chain.

In an example of a method for bringing about the presence of the indicated monomer unit in molecular chain terminal position on the polyester resin A, at least one monocarboxylic acid selected from the group consisting of aliphatic monocarboxylic acids having from 1 to 6 carbons and aromatic monocarboxylic acids having from 7 to 12 carbons (also collectively referred to in the following simply as “the monocarboxylic acid”) is condensed into the terminal position of the polyester molecular chain.

That is, the polyester resin A preferably is a polyester resin in which the hydroxyl group in polyester resin A has been endcapped with the monocarboxylic acid.

Condensation into the terminal position of the polyester molecular chain is facilitated when the number of carbons in the monocarboxylic acid is in the indicated range.

The aliphatic monocarboxylic acid can be exemplified by formic acid, acetic acid, propionic acid, butyric acid, valeric acid, and caproic acid.

The aromatic monocarboxylic acid can be exemplified by benzoic acid and cinnamic acid.

The monocarboxylic acid is preferably an aromatic monocarboxylic acid and is more preferably benzoic acid.

The content in the polyester resin A of the monocarboxylic acid-derived monomer unit is preferably from 0.5 mass % to 20.0 mass %, more preferably from 1.0 mass % to 10.0 mass %, and still more preferably from 2.0 mass % to 8.0 mass %.

When the content of the monocarboxylic acid is in the indicated range, this provides an even better toner particle dispersibility and enables a better suppression of the moisture-induced reduction in the dispersion stability of the liquid developer even in high-humidity environments.

The polyester resin A has an acid group and a hydroxyl group.

The acid value (AV) of the polyester resin A is preferably at least 3.0 mg KOH/g, more preferably at least 5.0 mg KOH/g, and still more preferably at least 10.0 mg KOH/g.

The upper limit for the acid value (AV) of the polyester resin A is not particularly limited, but is preferably not more than 40.0 mg KOH/g, more preferably not more than 30.0 mg KOH/g, and still more preferably not more than 25.0 mg KOH/g.

Any combination of these numerical value ranges can be used.

The acid value of the polyester resin A can be controlled through, for example, the type of alcohol component and acid component constituting the polyester resin A, the number of terminal groups in the polyester resin A, and the number of carboxy groups in the number of terminal groups.

Adsorption of the toner particle dispersing agent to the toner particle is facilitated and the dispersibility of the liquid developer is further enhanced when the acid value of the polyester resin A is in the indicated range.

On the other hand, the hydroxyl value (OHV) of this polyester resin is preferably not more than 25.0 mg KOH/g, more preferably not more than 20.0 mg KOH/g, still more preferably not more than 15.0 mg KOH/g, and particularly preferably not more than 10.0 mg KOH/g.

The lower limit for the hydroxyl value (OHV) of this polyester resin is not particularly limited, but is preferably at least 0.2 mg KOH/g, more preferably at least 0.5 mg KOH/g, and still more preferably at least 1.0 mg KOH/g.

Any combination of these numerical value ranges can be used.

The hydroxyl value of the polyester resin A can be controlled through, for example, the type of alcohol component and acid component constituting the polyester resin A, the number of terminal groups in the polyester resin A, and the number of hydroxyl groups in the number of terminal groups.

The dispersion stability of the liquid developer is further enhanced when the hydroxyl value of the polyester resin A is in the indicated range.

Using AV for the acid value of the polyester resin A and OHV for the hydroxyl value of the polyester resin A, this AV is preferably at least 5.0 mg KOH/g and this OHV and AV preferably satisfy the relationship OHV/AV≤3.5.

The relationship OHV/AV≤1.7 is more preferably satisfied; the relationship OHV/AV≤1.3 is still more preferably satisfied; and the relationship OHV/AV≤1.0 is particularly preferably satisfied.

The lower limit for this OHV/AV is not particularly limited, but at least 0.5 is preferred and at least 1.0 is more preferred.

Any combination of these numerical value ranges can be used.

The polyester resin A is preferably the condensation polymer of an alcohol with a carboxylic acid.

This alcohol can be exemplified by the following:

alkylene oxide adducts on bisphenol A, e.g., polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane, as well as ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

The carboxylic acid can be exemplified by the following:

aromatic dicarboxylic acids such as phthalic acid, isophthalic acid, and terephthalic acid and their anhydrides; alkyl dicarboxylic acids such as succinic acid, adipic acid, sebacic acid, and azelaic acid and their anhydrides; succinic acid substituted by an alkyl group or alkenyl group having 6 to 18 carbons, and anhydrides thereof; unsaturated dicarboxylic acids such as fumaric acid, maleic acid, and citraconic acid and their anhydrides.

In addition, the following monomers may also be used in addition to the preceding:

polyhydric alcohols such as sorbitol, sorbitan, and the oxyalkylene ethers of novolac-type phenolic resins; and polybasic carboxylic acids such as trimellitic acid, pyromellitic acid, benzophenonetetracarboxylic acid, and their anhydrides.

This basic toner particle dispersing agent can bring about the stable dispersion of toner particles in the carrier liquid. The dispersion stability of the toner particles over time is enhanced through the use of this basic toner particle dispersing agent.

The basic toner particle dispersing agent is preferably an amine (primary amine, secondary amine, or tertiary amine) and is more preferably a primary amine. That is, this basic toner particle dispersing agent preferably has an amino group (—NH₂).

The amine value of this toner particle dispersing agent is preferably from 10 mg KOH/g to 200 mg KOH/g and is more preferably from 20 mg KOH/g to 100 mg KOH/g.

By having the amine value of this toner particle dispersing agent satisfy the aforementioned range, a more substantial interaction with the polyester resin A is established and dissolution of the toner particle dispersing agent into the carrier liquid is further suppressed.

The toner particle dispersing agent may dissolve or may disperse in the carrier liquid.

Specific examples of this basic toner particle dispersing agent are provided in the following, but this should not be understood as a limitation thereto or thereby.

Examples within the sphere of commercial products are Ajisper PB-817 (primary amine: reaction product of a polyallylamine with a self-condensate of 12-hydroxystearic acid, Ajinomoto Fine-Techno Co., Inc.), Solsperse 11200, 13940, 17000, and 18000 (Lubrizol Japan Ltd.), and Lipidure-S (tertiary amine, NOF corporation).

The basic toner particle dispersing agent is more preferably an amino group-bearing polymer that has the amino group in a position other than terminal position on the polymer main chain, such as Ajisper PB-817.

From the standpoint of maintaining the dispersion stability, the content of the basic toner particle dispersing agent in the liquid developer is preferably from 0.5 mass parts to 20.0 mass parts, more preferably from 0.7 mass parts to 15.0 mass parts, further preferably from 1.0 mass parts to 10.0 mass parts, per 100 mass parts of the toner particle.

A single such basic toner particle dispersing agent may be used by itself or two or more may be used in combination.

The toner particle may contain a colorant.

There are no particular limitations on this colorant, and any generally commercially available organic pigment and inorganic pigment can be used, as can a pigment dispersed in, for example, an insoluble resin as a dispersion medium, as well as pigments provided by grafting a resin onto the pigment surface.

Specific examples of the pigment are provided in the following, but this should not be understood as a limitation thereto or thereby.

The following are specific examples of organic pigments and inorganic pigments that exhibit a yellow color:

C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and C.I. Vat Yellow 1, 3, and 20.

The following are examples of pigments that exhibit a red or magenta color:

C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, and 269; C.I. Pigment Violet 19; and C.I. Vat Red 1, 2, 10, 13, 15, 23, 29, and 35.

The following are examples of pigments that exhibit a blue or cyan color:

C.I. Pigment Blue 2, 3, 15:2, 15:3, 15:4, 16, and 17; C.I. Vat Blue 6; C.I. Acid Blue 45; and copper phthalocyanine pigments in which 1 to 5 phthalimidomethyl groups are substituted on the phthalocyanine skeleton.

The following are examples of pigments that exhibit a green color:

C.I. Pigment Green 7, 8, and 36.

The following are examples of pigments that exhibit an orange color:

C.I. Pigment Orange 66 and 51.

The following are examples of pigments that exhibit a black color:

Carbon black, titanium black, and aniline black.

Specific examples of white pigments are as follows:

Basic lead carbonate, zinc oxide, titanium oxide, and strontium titanate.

The content of the colorant, per 100 mass parts of the resin component in the toner particle, is preferably from 5 mass parts to 100 mass parts, more preferably from 10 mass parts to 80 mass parts, and still more preferably from 15 mass parts to 50 mass parts.

A disperser, as exemplified by the following, may be used to disperse the pigment:

Ball mill, sand mill, attritor, roll mill, jet mill, homogenizer, paint shaker, kneader, agitator, Henschel mixer, colloid mill, ultrasound homogenizer, pearl mill, and wet jet mill.

A pigment dispersing agent and/or a pigment dispersion auxiliary may also be used when pigment dispersion is carried out.

This pigment dispersing agent and pigment dispersion auxiliary can be exemplified by the esters of hydroxyl group-bearing carboxylic acids, the salts of high-molecular-weight acid esters and long-chain polyaminoamides, the salts of high-molecular-weight polycarboxylic acids, esters of high-molecular-weight unsaturated acids, high-molecular-weight copolymers, polyesters and modifications thereof, modified polyacrylates, aliphatic polybasic carboxylic acids, naphthalenesulfonic acid/formalin condensates, polyoxyethylenealkyl phosphate esters, and pigment derivatives.

Also usable are commercial pigment dispersing agents such as the Solsperse series from Lubrizol Japan Ltd. and the Vylon (registered trademark) UR series from Toyobo Co., Ltd. A synergist corresponding to the particular pigment may also be used.

The amount of addition of these pigment dispersing agents and pigment dispersion auxiliaries is preferably from 1 mass parts to 100 mass parts per 100 mass parts of the pigment.

The method for adding the pigment dispersing agent and pigment dispersion auxiliary is not particularly limited, but addition in a pigment dispersion step is preferred from the standpoint of the pigment dispersibility.

The carrier liquid present in the liquid developer preferably is nonvolatile at normal temperatures and exhibits electrical insulating behavior.

In addition, low-dielectric constant carrier liquids having a dielectric constant of not more than 3 are advantageous. This is because the electrostatic latent image is normally not disturbed when the carrier liquid has a resistance value in the indicated range. This carrier liquid is also preferably odorless and nontoxic.

The carrier liquid can be exemplified by aliphatic hydrocarbons, alicyclic hydrocarbons, aromatic hydrocarbons, halogenated hydrocarbons, polysiloxanes, silicone oils, animal and plant oils, mineral oils, and so forth.

Normal-paraffin solvents and isoparaffin solvents are preferred from the standpoints of odor, lack of toxicity, and cost.

Examples at a more specific level are Moresco White P40 (trade name), Moresco White P60 (trade name), and Moresco White P120 (trade name), from the MORESCO Corporation; Isopar (trade name, ExxonMobil Chemical); Shellsol 71 (trade name, Shell Petrochemicals Co., Ltd.); and IP Solvent 1620 (trade name, Idemitsu Petrochemical Co., Ltd.) and IP Solvent 2028 (trade name, Idemitsu Petrochemical Co., Ltd.).

An electrically insulating carrier liquid that is nonvolatile at normal temperature, and that is at the same time a curable carrier liquid that does not impart fixability to the toner particle, may also be used.

In the case of use of a curable carrier liquid, the carrier liquid can be selected from polymerizable liquid monomers. The polymerizable liquid monomer can be exemplified by acrylic monomers, vinyl ether compounds, and cyclic ether monomers such as epoxides and oxetanes.

The liquid developer may as necessary contain a charge control agent. Known charge control agents can be used as this charge control agent.

Specific compounds are, for example, fats and oils such as linseed oil and soybean oil; alkyd resins; halogen polymers; aromatic polycarboxylic acids; acidic group-containing water-soluble dyes; oxidative condensates of aromatic polyamines; metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate; sulfonate metal salts such as metal petroleum sulfonates and metal salts of sulfosuccinate esters; phospholipids such as hydrogenated lecithin and lecithin; metal salicylate salts such as metal complexes of t-butylsalicylic acid; as well as polyvinylpyrrolidone resins, polyamide resins, sulfonic acid-containing resins, and hydroxybenzoic acid derivatives.

Besides the preceding, suitable selections from various known additives, for example, surfactants, lubricants, fillers, defoamants, ultraviolet absorbers, oxidation inhibitors, antifading agents, antimolds, rust inhibitors, and so forth, may be used on an optional basis in the liquid developer with the goals of improving the recording medium compatibility, storage stability, image storability, and other properties.

The liquid developer can be advantageously used in ordinary or common image-forming apparatuses that employ an electrophotographic system.

There are no particular limitations on the method for producing the liquid developer, and known methods, e.g., a coacervation method, wet pulverization method, and so forth, can be used.

The details of the coacervation method are described in, for example, Japanese Patent Application Laid-open No. 2003-241439, WO 2007000974, and WO 2007/000975.

In the coacervation method, a resin component containing the polyester resin A, a basic toner particle dispersing agent, a solvent that dissolves this resin component, and a solvent that does not dissolve this resin component are intermixed, and the solvent that dissolves the resin component is then removed from the resulting mixture, causing the precipitation of the resin component, which had been in a dissolved state, and resulting in the dispersion of toner particles in the solvent that does not dissolve the resin component.

For example, a favorable example of the production method comprises:

a pigment dispersion step of preparing a pigment dispersion that contains a polyester resin A-containing resin component, pigment, basic toner dispersing agent, and solvent that dissolves this resin component;

a mixing step of adding, to the pigment dispersion, a solvent that does not dissolve the polyester resin A and preparing a mixture; and a distillative removal step of distillatively removing, from the mixture, the solvent that dissolves the resin component.

Solvents usable in the pigment dispersion step should be solvents that can dissolve the polyester resin A, but are not otherwise particularly limited. Examples here are ethers such as tetrahydrofuran; ketones such as methyl ethyl ketone, cyclohexanone, and acetone; esters such as ethyl acetate; and halides such as chloroform. In addition, the solvent may be an aromatic hydrocarbon, e.g., toluene, benzene, and so forth, when such has the ability to dissolve the resin.

A hydrocarbon organic solvent, e.g., n-hexane, an isoparaffin solvent, and so forth, or a silicone oil can be suitably used as the solvent that does not dissolve polyester resin A for use in the mixing step. The liquid developer can be produced by carrying out toner particle production using such a solvent and carrying out either the addition of, or substitution with, the carrier liquid.

The carrier liquid may also be used as the solvent that does not dissolve polyester resin A in the mixing step.

On the other hand, the details of the wet pulverization method are described in, for example, WO 2006/126566 and WO 2007/108485.

In this wet pulverization method, the pigment and the polyester resin A-containing resin component are kneaded at or above the melting point of the resin component; this is followed by dry pulverization; and the resulting pulverizate is wet-pulverized in the carrier liquid to bring about dispersion of the toner particles in the carrier liquid.

The methods used to measure the properties pertaining to the present invention are described in the following.

### <Structural Analysis of the Polyester Resin A in the Toner Particle>

The toner particle is separated from the liquid developer by centrifugal separation and washing.

Specifically, 50 mL of the liquid developer is introduced into a centrifuge tube and centrifugal separation is carried out using a centrifugal separator (Allegra 64R Centrifuge, Beckman Coulter, Inc.) and conditions of 15,000 rpm and 10 minutes.

Toner particle sedimentation is confirmed; the supernatant is removed by decantation; and hexane is added in the same amount as the supernatant that has been removed. A thorough washing by the hexane is performed by stirring for 5 minutes with a spatula, and centrifugal separation is subsequently carried out again using the same conditions. After hexane has been added and removed three times, the hexane is evaporated at room temperature to obtain the toner particle.

Compositional analysis of the polyester resin A constituting the toner particle is carried out by measuring the ¹H-NMR and ¹³C-NMR spectra of the obtained toner particles using an ECA-400 (400 MHz) from JEOL Ltd.

The measurement is run at 25° C. in a deuterated solvent containing tetramethylsilane as the internal reference substance.

The content of the monocarboxylic acid-derived monomer unit in the total monomer units constituting polyester resin A is determined from the obtained results.

<Method for Measuring the Molecular Weight of the Resin Component>

The molecular weight of the resin component is determined as polystyrene using gel permeation chromatography (GPC). The method for measuring the molecular weight using GPC is described in the following.

Sample sufficient to provide a sample concentration of 1.0 mass % is added to the eluent indicated below, and a solution in which the sample is dissolved is prepared by standing for 24 hours at room temperature. This solution is filtered across a solvent-resistant membrane filter having a pore diameter of 0.20 μm to provide the sample solution, and the measurement is run using the following conditions.

Instrument: “HLC-8220GPC” high-performance GPC instrument [Tosoh Corporation]

### Column: 2×LF-804

Eluent: tetrahydrofuran (THF)
Flow rate: 1.0 mL/min
Oven temperature: 40° C.
Sample injection amount: 0.025 mL

A molecular weight calibration curve constructed using polystyrene resin standards [Tosoh Corporation, TSK Standard Polystyrene F-850, F-450, F-288, F-128, F-80, F-40, F-20, F-10, F-4, F-2, F-1, A-5000, A-2500, A-1000, A-500] is used to determine the molecular weight of the sample.

<Method for Measuring the 50% Particle Diameter on a Volume Basis (D50) and the 95% Particle Diameter on a Volume Basis (D95) of the Toner Particle>

D50 and D95 of the toner particle are measured in the corresponding carrier liquid using a dynamic light-scattering (DLS) particle size distribution analyzer (trade name: Nanotrac 150, MicrotracBEL Corporation).

<Method for Measuring the Acid Value>

The basic procedure for measuring the acid value is based on JIS K 0070.

The determination is specifically carried out using the following method.

1) 0.5 to 2.0 g of the sample is exactly weighed. This mass is designated M1 (g).

2) The sample is introduced into a 50-mL beaker, 25 mL of a tetrahydrofuran/ethanol (21) mixed solvent is added, and dissolution is carried out.

3) Titration is performed using a 0.1 mol/L ethanolic KOH solution and a potentiometric titrator (“COM-2500” Automatic Titrator from Hiranuma Sangyo Co., Ltd.).

4) The amount of the KOH solution used here is designated S1 (mL). The blank is measured at the same time, and the amount of KOH used in this case is designated B1 (mL).

5) The acid value is calculated using the following formula. Here, f is the factor for the KOH solution.

acid value[mg KOH/g]=(S1−B1)×f×5.61/M1

<Method for Measuring the Hydroxyl Value>

The basic procedure for measuring the hydroxyl value is based on JIS K 0070-1992.

The determination is specifically carried out using the following method.

1) 25 g of special-grade acetic anhydride is introduced into a 100-mL volumetric flask; the total volume is brought to 100 mL by the addition of pyridine; and an acetylation reagent is then provided by thorough shaking.

The obtained acetylation reagent is stored in a brown bottle isolated from contact with, e.g., humidity, carbon dioxide, and so forth.

2) 0.5 to 2.0 g of the sample is exactly weighed. This mass is designated M2 (g).

3) The sample is introduced into a 50-mL beaker, 25 mL of a tetrahydrofuran/ethanol (2/1) mixed solvent is added, and dissolution is carried out.

4) 5.0 mL of the aforementioned acetylation reagent is precisely added to this using a volumetric pipette. A small funnel is mounted in the mouth of the flask and heating is then carried out by immersing about 1 cm of the bottom of the flask in a glycerol bath at approximately 97° C. In order at this point to prevent the temperature at the neck of the flask from rising due to the heat from the bath, thick paper in which a round hole has been made is preferably mounted at the base of the neck of the flask.

5) After 1 hour, the flask is taken off the glycerol bath and allowed to cool. After cooling, the acetic anhydride is hydrolyzed by adding 1 mL of water from the funnel and shaking. In order to accomplish complete hydrolysis, the flask is again heated for 10 minutes on the glycerol both.

6) Titration is performed using a 0.1 mol/L ethanolic KOH solution and a potentiometric titrator (“COM-2500” Automatic Titrator from Hiranuma Sangyo Co., Ltd.).

The amount consumed by titration at this time is designated C (mL). The blank is measured at the same time, and the amount of KOH used in this case is designated D (mL).

7) The hydroxyl value is calculated by substituting the obtained results into the following formula.

hydroxyl value [mg KOH/g]=[(D−C)×28.05×f/M2]+acid value [mg KOH/g]

<Measurement of Amine Value>

The basic procedure for determining the amine value of the basic toner dispersing agent is based on ASTM D 2074.

Specifically, the amine value is determined using the following method.

1) 0.5 to 2.0 g of the sample is exactly weighed. This mass is designated M3 (g).

2) The sample is introduced into a 50-mL beaker, 25 mL of tetrahydrofuran/ethanol mixed solvent (3/1) is added, and dissolution is carried out.

3) Titration is performed using a 0.1 mol/t ethanolic HCl solution and a potentiometric titrator. A “COM-2500” Automatic Titrator from Hiranuma Sangyo Co., Ltd. is used.

4) The amount of the HCl solution used here is designated S3 (mL). The blank is measured at the same time, and the amount of HCl used in this case is designated B3 (mL).

5) The amine value is calculated using the following formula. Here, f is the factor for the HCl solution.

amine value [mg KOH/g]=(S3−83)×f×5.61/M3

### EXAMPLES

The present invention is described in detail in the following using examples, but the present invention is not limited to or by these examples. Unless specifically indicated otherwise, “parts” and “%” denote, respectively, “mass parts” and “mass %”.

<Liquid Developer 1 Production Example>

### (Polyester Resin A1 Production Example)

| | | |
|---|---|---|
| ethylene oxide (2.5 mol) adduct on bisphenol A | 55 | parts |
| terephthalic acid | 43 | parts |
| tetrabutyl titanate | 0.2 | parts |
| trimellitic anhydride | 2 | parts |

These materials were metered into a reactor fitted with a condenser, stirrer, nitrogen introduction line, and thermocouple.

The interior of the reactor was substituted with nitrogen gas; the temperature was then gradually raised while stirring; and a reaction was run for 3 hours while stirring at a temperature of 140° C.

The pressure within the reactor was then dropped to 8.3 kPa and the temperature was raised to 200° C., and a reaction was then run for 4 hours while maintaining this temperature.

The pressure within the reactor was subsequently gradually released to return to normal pressure. This was followed by the addition of 8 parts of benzoic acid and a reaction was run for 2 hours at 200° C. under normal pressure.

The pressure within the reactor was then again reduced to 5 kPa or less and a reaction was run for 3 hours at 200° C. to obtain a polyester resin A1 having the property values given in Table 1.

(Polyester Resins A2 to A13 Production Example)

Polyester resins A2 to A13 were obtained proceeding as in the Polyester Resin A1 Production Example, but with appropriate changes in the type and amount of addition of the monocarboxylic acid and in the amounts of addition of the individual monomers.

TABLE 1

| | | | | | | Weight- | |
|---|---|---|---|---|---|---|---|
| Polyester | Type of | | Acid | Hydroxyl | | average | |
| resin A | monocarboxylic | A | value | value | OHV/ | molecular | |
| No. | add | (mass %) | mgKOH/g | mgKOH/g | AV | weight | *1 |
| 1 | Benzoic add | 5.5 | 13.8 | 9.0 | 0.7 | 14000 | Present |
| 2 | Acetic acid | 2.7 | 14.0 | 9.1 | 0.7 | 13200 | Present |
| 3 | Benzoic acid | 1.0 | 13.9 | 14.2 | 1.0 | 12900 | Present |
| 4 | Benzoic acid | 10.0 | 13.8 | 6.0 | 0.4 | 15000 | Present |
| 5 | Benzoic acid | 0.5 | 14.0 | 16.0 | 1.1 | 12500 | Present |
| 6 | Benzoic acid | 20.0 | 13.9 | 3.0 | 0.2 | 15800 | Present |
| 7 | Benzoic acid | 5.9 | 12.3 | 18.6 | 1.5 | 13100 | Present |
| 8 | Benzoic acid | 6.2 | 9.8 | 19.0 | 1.9 | 12800 | Present |
| 9 | Benzoic acid | 2.4 | 6.1 | 11.0 | 1.8 | 26000 | Present |
| 10 | Benzoic acid | 2.7 | 4.2 | 14.0 | 3.3 | 27300 | Present |
| 11 | Benzoic acid | 2.8 | 21.1 | 21.3 | 1.0 | 14300 | Present |
| 12 | Benzoic acid | 3.6 | 14.5 | 30.2 | 2.1 | 12100 | Present |
| 13 | — | — | 14.5 | 44.0 | 3.0 | 11400 | Absent |

*1: Presence/absence of monocarboxylic acid in molecular chain terminal position

In the table, A gives the content (mass %) of the monocarboxylic acid-derived monomer unit in the total monomer units constituting polyester resin A.

(Pigment Dispersion Step)

30 parts of C.I. Pigment Blue 15:3, 47 parts of Vylon UR4800 (32% resin concentration, Toyobo Co., Ltd.), 255 parts of tetrahydrofuran, and 130 parts of glass beads (1 mm diameter) were mixed; dispersion was performed for 3 hours using an attritor (Nippon Coke & Engineering Co., Ltd.); and filtration across a mesh was carried out to obtain a kneaded material.

332 parts of the obtained kneaded material, 230 parts of a 50% tetrahydrofuran solution of polyester resin A1, and 20 parts of a toner particle dispersing agent (Ajisper PB-817, polyallylamine/12-hydroxystearic acid self-condensate with an amine value of 15 mg KOH/g, Ajinomoto Fine-Techno Co., Inc.) were mixed at 40° C. using a high-speed disperser (T. K. Robomix/T. K. Homodisper Model 2.5 impeller, PRIMIX Corporation) to obtain a pigment dispersion.

### (Mixing Step)

A mixture was obtained by adding 100 parts of Moresco White P-40 (MORESCO Corporation), which is a carrier liquid, in small portions to 100 parts of the aforementioned pigment dispersion, while stirring at high speed (25,000 rpm) using a homogenizer (Ultra-Turrax T50, IKA).

### (Distillative Removal Step)

The resulting mixture was transferred to a recovery flask and the tetrahydrofuran was completely distilled off at 50° C. using a rotary evaporator while performing ultrasound dispersion to obtain a toner particle dispersion.

### (Liquid Developer Preparation Step)

Liquid developer 1 was obtained by combining 10 parts of the obtained toner particle dispersion, 0.10 parts of hydrogenated lecithin (Lecinol S-10. Nikko Chemicals Co., Ltd.) as a charge control agent, and 80.00 parts of Moresco White P-40 as a carrier liquid.

<Liquid Developers 2 to 19 Production Example>

Liquid developers 2 to 19 were obtained proceeding as for liquid developer 1, but changing the type of polyester resin A and the type and amount of the toner particle dispersing agent to the conditions indicated in Table 2.

TABLE 2

| | | |
|---|---|---|
| Liquid | Polyester | Toner particle |
| developer | resin A | dispersing agent |

| No. | No. | Type | Content |
|---|---|---|---|
| 1 | 1 | A | 12.5 |
| 2 | 2 | A | 12.5 |
| 3 | 3 | A | 12.5 |
| 4 | 4 | A | 12.5 |
| 5 | 5 | A | 12.5 |
| 6 | 6 | A | 12.5 |
| 7 | 7 | A | 12.5 |
| 8 | 8 | A | 12.5 |
| 9 | 9 | A | 12.5 |
| 10 | 10 | A | 12.5 |
| 11 | 10 | A | 0.5 |
| 12 | 10 | A | 20.0 |
| 13 | 10 | A | 0.2 |
| 14 | 10 | A | 30.0 |
| 15 | 11 | A | 30.0 |
| 16 | 12 | A | 30.0 |
| 17 | 12 | B | 30.0 |
| 18 | 13 | A | 12.5 |
| 19 | 12 | — | — |

With regard to the type of toner particle dispersing agent in the table,

A refers to Ajisper PB-817 and
B refers to Lipidure-S(NOF Corporation).

The content of the toner particle dispersing agent, on the other hand, refers to the content (parts) per 100 parts of the toner particle.

### Examples 1 to 17 and Comparative Examples 1 and 2

Liquid developers 1 to 19 were evaluated using the following methods.

### (Evaluation of the Developing Performance)

The liquid developer was introduced into the apparatus shown in the FIGURE for evaluating liquid development image quality, and the dot reproducibility on a photosensitive drum 10 was evaluated.

The constitution of the apparatus for evaluating liquid development image quality that was used in this evaluation is described in the following.

100 g of the liquid developer is introduced, as a solution of uniform concentration, into a liquid developer tank 16.

The liquid developer is coated on a supply roller 15 that has been adjusted to a prescribed potential and is transported to a developing roller 13.

The liquid developer transferred to the developing roller 13 is adjusted to a prescribed developer concentration (25 to 35 mass %) by a squeegee roller 14, and is transferred to a development nip between the developing roller 13 and the photosensitive drum 10.

An amorphous silicon drum is used for the photosensitive drum 10, and the surface of the photosensitive drum 10 is charged to −600 V by a charging device 11 that is upstream from the development nip.

After charging, a 1200 dpi 1 dot-1 space latent image is formed by an exposure device 12 so that the potential of the image area becomes −200 V. The circumferential velocity of the photosensitive drum 10 is 700 mm/s.

A bias of −400 V is applied to the developing roller 13 and the negatively charged developer is selectively transferred to the image area. The carrier liquid is separated at the development nip region to both the developing roller 13 and the photosensitive drum 10.

The evaluation apparatus is stopped before the developer developed from the developing roller 13 onto the photosensitive drum 10 reaches the position of the cleaning blade 17.

The photosensitive drum 10 is then immediately removed from the apparatus and the image on the photosensitive drum 10 is observed using a VHX-5000 digital microscope (Keyence Corporation).

The dot reproducibility was evaluated using the metrics given below. The results are given in Table 3.

This same evaluation was also carried out after the liquid developer had been stored for 1 month in a “30° C., 80% RH” environment (also referred to in the following as the HH environment), and this was used to indicate the development stability over time. The results are given in Table 3.

### <Evaluation Metrics>

5: The dots are uniform and chipping is entirely absent.
4: The dots are independent and defects such as scattering are also absent.
3: Dots can be recognized.
2: There are numerous regions in which dots cannot be recognized.
1: Dots cannot be recognized.

<Evaluation of the Particle Size Distribution of the Toner Particles>

The toner particle was evaluated using the ratio (D95/D50) of the 95% particle diameter on a volume basis (D95) to the 50% particle diameter on a volume basis (D50).

The evaluation criteria for the particle size distribution are given below. A score of 3 or better was regarded as good in this evaluation. The results of the evaluation are given in Table 3.

### 5: (D95/D50)≤2

### 4:2<(D95/D50)≤3

### 3: 3<(D95/D50)≤5

### 2: 5<(D95/D50)≤10

### 1: 10<(D95/D50)

<Evaluation of the Dispersion Stability>

The liquid developer was stored for 1 month in the HH environment.

The pre-storage and post-storage toner particle diameters were measured as the 50% particle diameter on a volume basis (D50) using a dynamic light-scattering (DLS) particle size distribution analyzer (trade name: Nanotrac 150, MicrotracBEL Corporation).

The toner particle dispersion stability was evaluated using the ratio of the post-storage toner particle diameter to the pre-storage toner particle diameter (post-storage D50/pre-storage D50).

The evaluation criteria for the dispersion stability are given below. A score of 3 or better was regarded as good in this evaluation. The results of the evaluation are given in Table 3.

5: (post-versus-pre-storage DSO ratio)≤1.1
4: 1.1<(post-versus-pre-storage D50 ratio)≤1.3
3: 1.3<(post-versus-pre-storage D50 ratio)≤1.5
2: 1.5<(post-versus-pre-storage D50 ratio)≤2.0
1: 2.0<(post-versus-pre-storage D50 ratio)

TABLE 3

| | | | | | | Dispersion stability | |
|---|---|---|---|---|---|---|---|
| | | | | | | Post-storage | |
| | Liquid | | Development | Dispersibility | | D50/ | |
| | developer | Developing | stability | D95/ | | Pre-storage | |
| | No. | performance | over time | D50 | Evaluation | D50 | Evaluation |
| Example 1 | 1 | 5 | 5 | 1.7 | 5 | 1.0 | 5 |
| Example 2 | 2 | 5 | 5 | 1.7 | 5 | 1.0 | 5 |
| Example 3 | 3 | 5 | 5 | 1.7 | 5 | 1.2 | 4 |
| Example 4 | 4 | 5 | 5 | 1.9 | 5 | 1.0 | 5 |
| Example 5 | 5 | 5 | 3 | 1.7 | 5 | 1.4 | 3 |
| Example 6 | 6 | 5 | 4 | 2.1 | 4 | 1.0 | 5 |
| Example 7 | 7 | 5 | 5 | 1.9 | 5 | 1.3 | 4 |
| Example 8 | 8 | 5 | 3 | 1.9 | 5 | 1.4 | 3 |
| Example 9 | 9 | 4 | 4 | 2.2 | 4 | 1.3 | 4 |
| Example 10 | 10 | 4 | 3 | 2.5 | 4 | 1.5 | 3 |
| Example 11 | 11 | 4 | 3 | 2.8 | 4 | 1.5 | 3 |
| Example 12 | 12 | 4 | 4 | 1.8 | 5 | 1.2 | 4 |
| Example 13 | 13 | 4 | 3 | 3.2 | 3 | 1.5 | 3 |
| Example 14 | 14 | 3 | 3 | 1.8 | 5 | 1.2 | 4 |
| Example 15 | 15 | 4 | 4 | 2.4 | 4 | 1.4 | 3 |
| Example 16 | 16 | 4 | 3 | 2.6 | 4 | 1.5 | 3 |
| Example 17 | 17 | 3 | 3 | 3.8 | 3 | 1.5 | 3 |
| Comparative | 18 | 4 | 2 | 2.2 | 4 | 1.7 | 2 |
| Example 1 | | | | | | | |
| Comparative | 19 | 2 | 1 | 6.1 | 2 | 2.2 | 1 |
| Example 2 | | | | | | | |

According to the present disclosure, a liquid developer that maintains the dispersion stability of a toner particle in the liquid developer, even in a high-humidity environment, and that exhibits an excellent development stability over time can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A liquid developer comprising a toner particle, a carrier liquid, and a basic toner particle dispersing agent, wherein
the toner particle contains a polyester resin A, and
the polyester resin A contains at least one monomer unit selected from the group consisting of monomer units derived from aliphatic monocarboxylic acids having from 1 to 6 carbons and monomer units derived from aromatic monocarboxylic acids having from 7 to 12 carbons.

2. The liquid developer according to claim 1, wherein the at least one monomer unit selected from the group consisting of monomer units derived from aliphatic monocarboxylic acids having from 1 to 6 carbons and monomer units derived from aromatic monocarboxylic acids having from 7 to 12 carbons is present at a molecular chain terminal of the polyester resin A.

3. The liquid developer according to claim 1, wherein a content of the at least one monomer unit selected from the group consisting of monomer units derived from aliphatic monocarboxylic acids having from 1 to 6 carbons and monomer units derived from aromatic monocarboxylic acids having from 7 to 12 carbons in total monomer units constituting the polyester resin A is from 1.0 mass % to 10.0 mass %.

4. The liquid developer according to claim 1, wherein when AV is an acid value of the polyester resin A and OHV is a hydroxyl value of the polyester resin A,
the AV is at least 5.0 mg KOH/g, and
the OHV and the AV satisfy relationship OHV/AV≤1.7.

5. The liquid developer according to claim 1, wherein a content of the basic toner particle dispersing agent is from 0.5 mass parts to 20.0 mass parts per 100 mass parts of the toner particle.

6. The liquid developer according to claim 1, wherein the hydroxyl value of the polyester resin A is not more than 20.0 mg KOH/g.

7. The liquid developer according to claim 1, wherein the basic toner particle dispersing agent is a primary amine.

8. A liquid developer comprising a toner particle, a carrier liquid, and a basic toner particle dispersing agent, wherein
the toner particle contains a polyester resin A having an acid group, and a hydroxyl group, and
the polyester resin A is a polyester resin in which the hydroxyl group of the polyester resin A is endcapped by at least one monocarboxylic acid selected from the group consisting of aliphatic monocarboxylic acids having from 1 to 6 carbons and aromatic monocarboxylic acids having from 7 to 12 carbons.
